(19) United States
(12) Patent Application Publication
(10) Pub. No.: US 2010/0186601 A1
(43) Pub. Date: Jul. 29, 2010

(54) Upper Griddle Cooking Mechanism

(76) Inventor: Bektas Cinar Gulkanat, Charlotte, NC (US)

Correspondence Address: THOMPSON HINE LLP;Intellectual Property Group, P.O Box 8801, DAYTON, OH, 45401-8801, US

(21) Appl. No.: 12/642,997

(22) Filed: Dec. 21, 2009

Related U.S. Application Data
(60) Provisional application No. 61/147,079, filed on Jan. 24, 2009.

(51) Int. Cl. A47J 37/06; A47J 37/00

(52) U.S. Cl. 99/372; 99/422

(57) ABSTRACT

An upper griddle mechanism for use with a cooking apparatus having a griddle plate with an upwardly facing cooking surface is provided. The upper griddle mechanism includes an upright mount column portion and an arm portion pivotally connected to the mount column portion, the arm portion including an upper griddle plate. The arm portion is pivotally movable relative to the mount column portion between a lowered cooking position and a raised non-cooking position. The upper griddle mechanism may include one or more of (i) a biasing mechanism is mounted between the mount column portion and the arm portion to bias the arm portion, (ii) a locking mechanism releasably holds the arm portion in the raised non-cooking position and/or a stabilizer member that interacts with the griddle plate when the arm portion is in the raised non-cooking position to restrict relative movement between the griddle plate and the body of the arm.

### CROSS-REFERENCES

This application claims the benefit of U.S. Provisional Application Ser. No. 61/147,079, filed Jan. 24, 2009.

### TECHNICAL FIELD

The present invention relates generally to cooking griddles and, more particularly, to a movable upper griddle mechanism for use with cooking griddles.

### BACKGROUND

Two-sided cooking (e.g., cooking with heat applied from griddle plate members both above and below the food product) generally reduces the overall cooking time and the amount of operator attention required for cooking the food products. Not only is cooking time dramatically reduced with two-sided cooking, but certain foods such as hamburgers, are improved in taste and texture by the application of force (e.g., a compressing of sandwiching type force) during the cooking process. Therefore, two-sided griddle-type cooking devices, also known as clam shell griddles, are highly desirable in fast food restaurants.

It would be desirable to provide an upper griddle mechanism adaptable to existing product lines and facilitating ease of operator use.

### SUMMARY

In one aspect, an upper griddle mechanism for use with a cooking apparatus having a griddle plate with an upwardly facing cooking surface is provided. The upper griddle mechanism includes an upright mount column portion and an arm portion pivotally connected to the mount column portion, the arm portion including an upper griddle plate. The arm portion is pivotally movable relative to the mount column portion between a lowered cooking position and a raised non-cooking position. A biasing mechanism is mounted between the mount column portion and the arm portion to bias the arm portion.

In another aspect, an upper griddle mechanism for use with a cooking apparatus having a griddle plate with an upwardly facing cooking surface is provided. The upper griddle mechanism includes an upright mount column portion and an arm portion connected to the mount column portion, the arm portion including an upper griddle plate. The arm portion is pivotally movable relative to the mount column portion between a lowered cooking position and a raised non-cooking position. A locking mechanism releasably holds the arm portion in the raised non-cooking position, the locking mechanism including a handle assembly located at an end of the arm portion that is spaced from the mount column portion. The handle assembly includes a fixed handle portion and a pivoting handle portion, movement of the pivoting handle portion toward the fixed handle portion releases the locking mechanism to enable the arm portion to pivot from the raised non-cooking position to the lowered cooking position.

In a further aspect, an upper griddle mechanism for use with a cooking apparatus having a griddle plate with an upwardly facing cooking surface is provided. The upper griddle mechanism includes an upright mount column portion and an arm portion connected to the mount column portion, the arm portion including an upper griddle plate assembly. The arm portion is pivotally movable relative to the mount column portion between a lowered cooking position and a raised non-cooking position, and the upper griddle plate assembly is floatingly connected to an arm body of the arm portion. At least one stabilizer member interacts with the griddle plate assembly when the arm portion is in the raised non-cooking position to restrict relative movement between the griddle plate assembly and the arm body, the stabilizer member automatically releasing the griddle plate assembly when the arm portion is moved to the lowered cooking position.

The details of one or more embodiments are set forth in the accompanying drawings and the description below. Other features, objects, and advantages will be apparent from the description and drawings, and from the claims.

### BRIEF DESCRIPTION OF DRAWINGS

FIG. 1 is a perspective view of a an upper griddle mechanism;

FIG. 2 is a side elevation of the upper griddle mechanism in a non-cooking position relative to a griddle apparatus;

FIG. 3 is a side elevation of the upper griddle mechanism in a cooking position relative to a griddle apparatus;

FIGS. 4A and 4B are partial perspective views of the upper griddle mechanism with arm raised in a non-cooking position;

FIGS. 5A and 5B are partial perspective views of the upper griddle mechanism with arm lowered in a cooking position;

FIG. 6 is a partial perspective, with components removed, or the upper griddle mechanism;

FIG. 7 is an enlarged partial side view of the connection between the arm and mount column;

FIG. 8 is an enlarged partial side view of the front of the arm; and

FIG. 9 is a rear perspective rear view of a griddle apparatus showing a bracket attachment system for the upper griddle mechanism.

### DETAILED DESCRIPTION

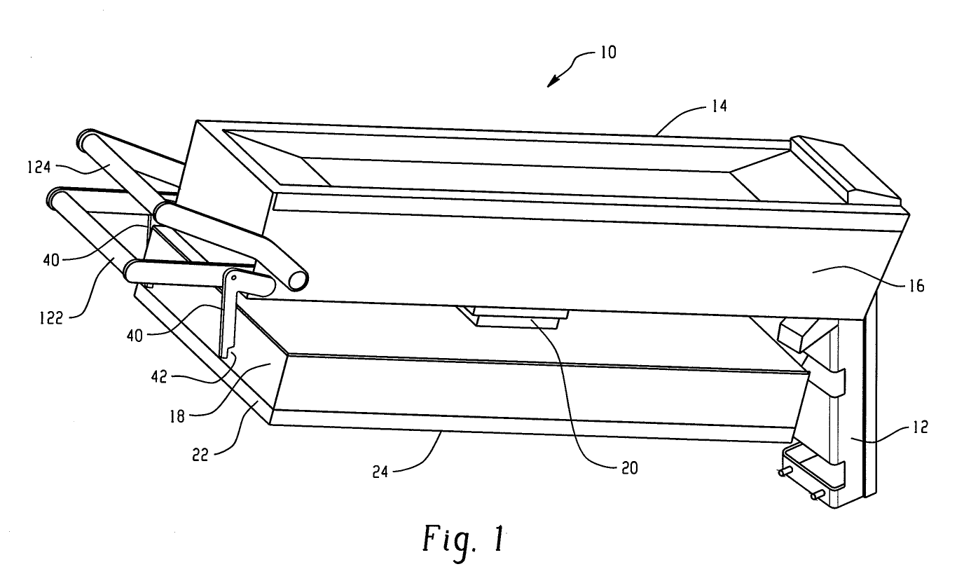

Referring to FIG. 1, a perspective view of one embodiment of an upper griddle mechanism 10 is shown. The upper griddle mechanism 10 includes an upright mount column 12 and an arm 14 pivotally connected to the mount column. The arm 14 includes an arm body or frame 16 and an upper griddle plate assembly 18 connected to an underside of the arm body 16. The connecting joint between the arm body 16 and the griddle plate assembly 18 is preferably a universal type joint surrounded by a collar 20 that enables the griddle plate assembly to float relative to the arm body. Power for the heat resistive elements in the griddle plate assembly is also delivered through a conductive path surrounded by the collar. In this regard, the exact structure of the griddle plate assembly may vary, but the griddle plate assembly generally includes a griddle plate 22 with a lower, heated cooking surface 24 that can rest atop food product for cooking the food product.

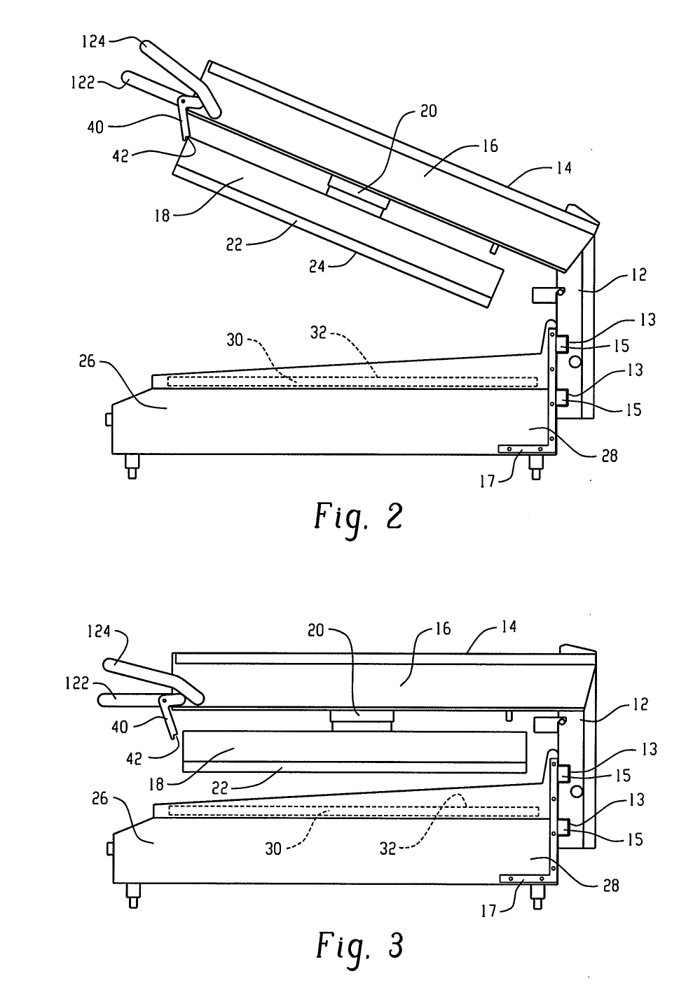

Referring to FIGS. 2 and 3, the upper griddle mechanism is shown mounted to an exemplary griddle apparatus 26 having a griddle body 28 and a griddle plate 30 with an upwardly facing cooking surface 32. The upper griddle mechanism of the invention is intended for use with a variety of cooking griddle apparatus, including counter top size griddle apparatus as shown, as well as standard size griddle apparatus (e.g., griddles having a body/frame sized for placement on the floor of a cooking environment). The mount column 12 is used to secure the upper griddle mechanism to the griddle apparatus at the rear side of the griddle body/frame, but could be secured to the griddle/apparatus body/frame at other locations, such as the left or right side.

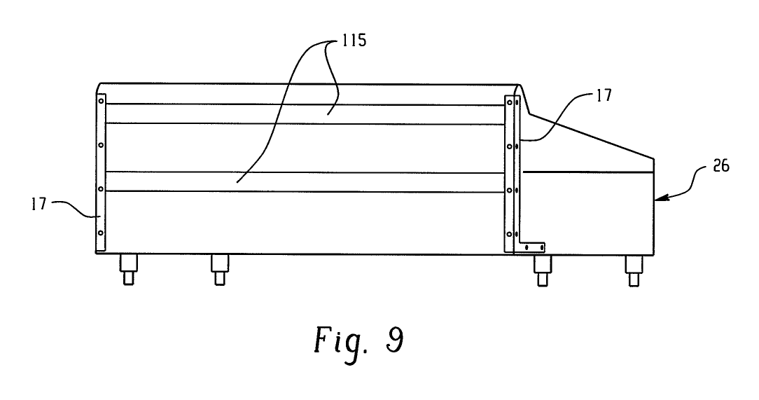

In the illustrated embodiment, the body of the mount column 12 includes slots 13 that face toward the rear side of the griddle body and into which square mount brackets 15 are positioned. The square mount brackets are secured to the griddle apparatus utilizing a pair of L-shaped brackets 17 that are secured to each side of the griddle apparatus at the rear corners (e.g., using machine screws), with the mount brackets 15 extending laterally between the two brackets 17. The interaction of the mount brackets and slots provided increased stability to the mount connection. Fasteners may be used to further secure the mount column to the rear panel of the griddle apparatus. FIG. 9 shows a rear perspective of the mounting bracket arrangement on the griddle apparatus 26, with the upper griddle apparatus not shown for clarity. This mount bracket arrangement is generally suitable for the many variety of griddle apparatus that exist in the marketplace, facilitating aftermarket modification of such griddle apparatus to receive the upper griddle mechanism.

As shown, the arm 14 is pivotally movable relative to the mount column 12 for movement between a lowered cooking position (FIG. 3) and a raised non-cooking position (FIG. 2). The mount column 12 is mounted to the cooking apparatus 26 and extends above the upwardly facing griddle surface 32. When the arm 14 is in the cooking position the lower cooking surface 24 of the upper griddle plate 22 opposes the upwardly facing cooking surface 32 of the lower griddle plate so that food items can be heated and cooked from both above and below by the two heated surfaces. When the arm 14 is in the raised non-cooking position food items can removed from or placed on the lower griddle plate 30, or otherwise manipulated on the griddle plate 30.

The front end of the arm 14 includes a pair of spaced apart griddle plate assembly stabilizers 40 that freely pivot relative to the arm body 16. When the arm 14 is in the cooking position lower ends 42 of the stabilizers hang downward in front of the griddle plate assembly 18. When the arm is raised into the non-cooking position the stabilizers pivot toward the griddle plate assembly 18 under the force of gravity and contact the upper edge of the griddle plate assembly. The lower ends 42 include a notch configured to engage with the corner of the griddle plate assembly in a manner that tends to capture the griddle plate assembly. When the stabilizers are in the capture position the floating movement of the griddle plate assembly is restricted by the stabilizers, facilitating cleaning of the cooking surface 24 of the upper griddle plate 22.

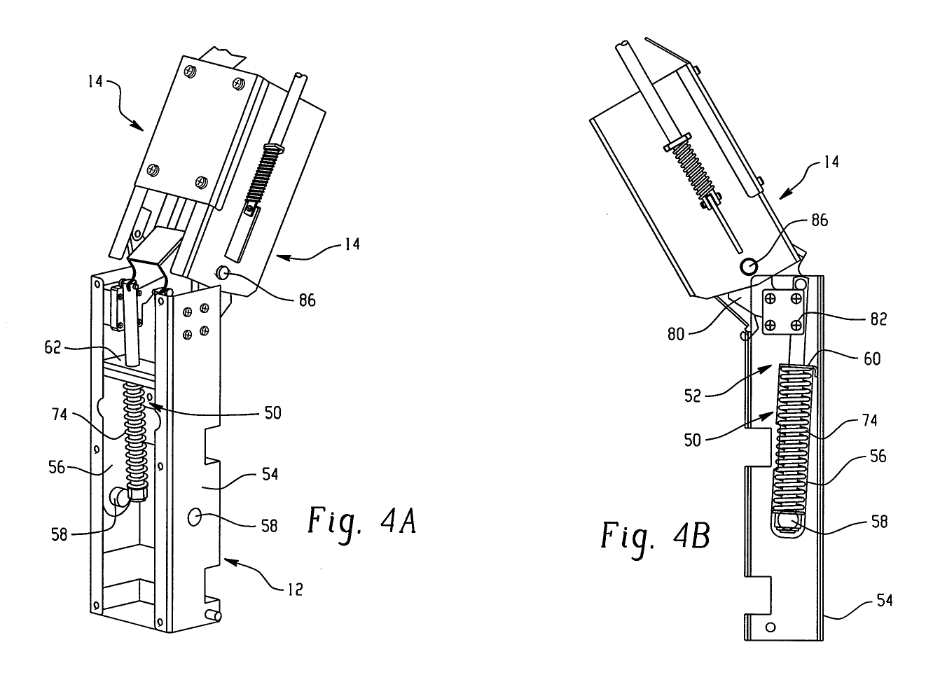

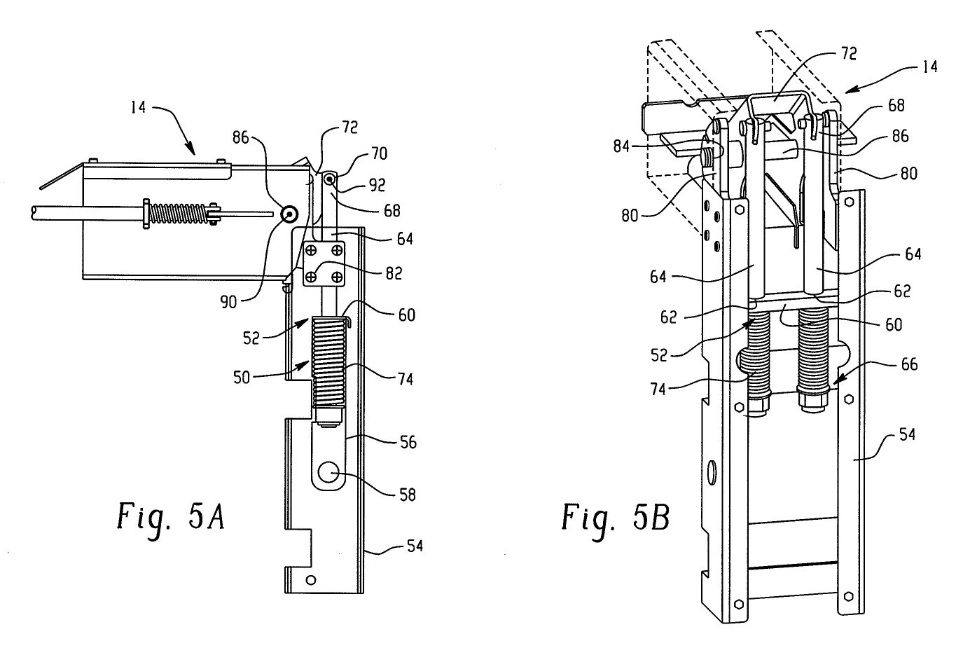

Referring now to FIGS. 4 and 5, a biasing mechanism 50 is provided between the arm portion 14 and the mount column 12 as shown. Specifically, the biasing mechanism includes an inverted U-shaped bracket 52 located on a body/frame 54 of the mount column 12 portion. Downwardly extending legs 56 of the bracket are pivotally connected to sides of the body 54 by pins 58. The upper side of the bracket connects the legs 56 and defines a spring retainer 60 with spaced apart openings 62 therethrough. Rods 64 pass through the spaced apart openings of the spring retainer and having lower ends 66 positioned below the spring retainer and upper ends 68 positioned above the spring retainer. The rods are movable through the openings relative to the spring retainer, and the upper ends of the rods are pivotally connected to the arm 14 via pivot pins 70 associated with an arm bracket 72.

Springs 74 are disposed about each rod 64 below the spring retainer 60 and have upper ends seated against the spring retainer. The lower end of each rod is threaded and includes a nut and washer arrangement, with each washer positioned to engage the lower end of a respective spring. Thus, the upper end of each spring seats against the lower surface of spring retainer 60 and the bottom end of each spring seats against a surface defined by a respective washer. The lower end of each spring is thus movable relative to the spring retainer moves upward with the lower end of its respective rod when the arm 14 is pivoted from the non-cooking position to the cooking position, thereby compressing the springs when the arm is in the cooking position. The compressed springs create a downward urging force on the rods 64 that tends to try and pull the arm back up into the non-cooking position. In this regard, the arm 14 has an actual weight W_{A} and the bias provided by springs when the arm is in the cooking position urges the arm portion upward, counteracting downward weight of the arm portion when the arm portion is in the cooking position, such that the arm portion has an effective weight W_{E} that is less than its actual weight. For example, the effective weight W_{E} is less than thirty percent (30%) of the actual weight W_{A}, and more preferably less than twenty percent (20%) of the actual weight (e.g., were the actual weight of the arm is 40 pounds, the effective weight may be between 4-10 pounds). In this manner, the downward force of the upper griddle plate against food product during cooking is reduced to an acceptable level, and the force required by an operator to move the arm 14 from the lowered cooking position up the raised non-cooking position is reduced for ergonomic convenience.

As shown, the upper ends of the rods 68 likewise move upward when the arm is moved to the cooking position, with the rods sliding along and through the openings 62 in the retainer 60. As best seen in a comparison of FIGS. 4B and 5A, the bracket 52 pivots slightly during movement of the arm 14 between the non-cooking and cooking positions.

The pivotal connection between the mount column 12 and the arm 14 is achieved using a pair of spaced apart brackets 80, each of which is fixedly connected to the a respective side of the column body 54, in the illustrated case by a set of four bolts or screws 82. The upper end of each bracket includes an opening 84 through which a pivot pin 86 extends, and the arm bracket 72 pivotally mounted on the pin 86. The pin 86 defines the primary pivot axis 90 of the arm 84 for movement between the non-cooking position and the cooking position. The upper end of each rod is pivotally connected to the arm at a location spaced from the primary pivot axis to define a secondary pivot axis 92 that runs parallel to the primary pivot axis. The primary pivot axis is stationary, while the secondary pivot axis moves during arm movement.

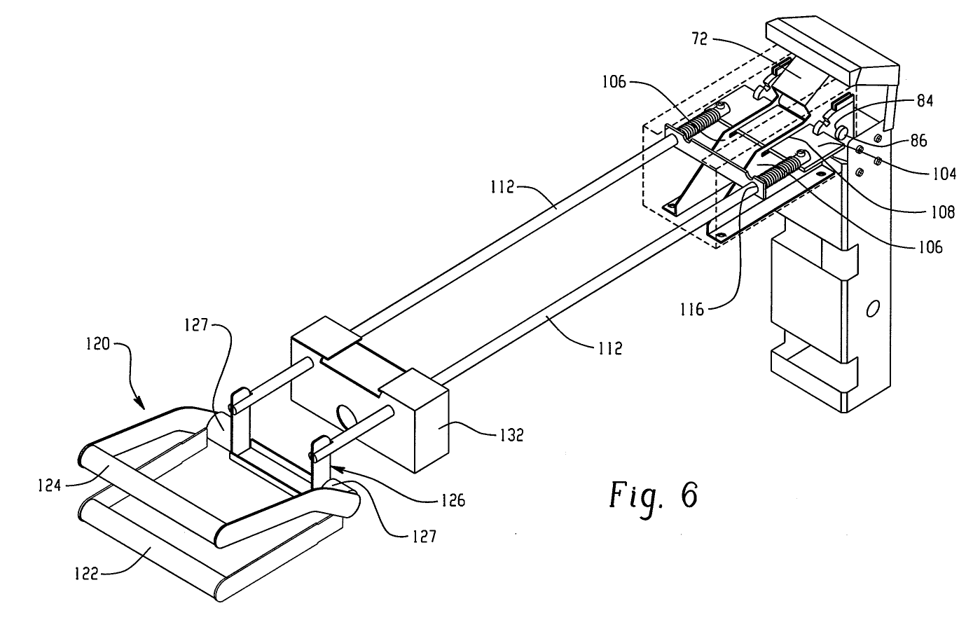

Referring now to FIGS. 6-8, the upper griddle mechanism includes a locking/latching feature for holding the arm 14 in the raised non-cooking position. In this regard, each bracket 80 includes an arcuate slide surface facing the locking plate, the arcuate slide surface 100 with at least one slot 102 formed therein for receiving a locking plate 104 when the arm portion is in the raised non-cooking position so as to releasably retain the arm portion in the raised non-cooking position. In the illustrated embodiment two slots 102 are provided, with each corresponding to a distinct raised non-cooking position of the arm 14 (e.g., one slot position placing the arm 14 at an upward angle of about 40-50 degrees relative to horizontal and the other slot position placing the arm 14 at an upward angle of about 80-90 degrees relative to horizontal). The arm bracket 72 includes upright guide panel segments 106 that have elongated slots 108 through which the locking plate 104 extends and along which the locking plate can slide. Springs 110 bias the locking plate 104 toward the locking brackets 80 such that the plate will move into the slots 102 when aligned therewith. Each spring 110 is disposed about an end portion of a rod 112, where the end of each rod 112 is connected to the edge of the locking plate 104 (e.g., via a suitable fastener arrangement). A spring retainer 114 is fixed within the arm 14 and included openings 116 through which the rods 112 extend. One end of each spring 110 seats against the spring retainer 114 and the opposite end engages the end of the rod, or the locking plate 104 directly. The springs 110 are pre-compressed such that the locking plate 104 is always biased toward the locking brackets 80. When the arm is located so that the edge of the locking plate 104 is not aligned with a slot 102, the edge will slide along the surfaces 100 until the plate 104 aligns with the slots 102 and the plate moves into the slots to releasably hold the position of the arm relative to the mount column. As shown, the surfaces 100 do not include any slots located to permit latching or locking when the arm 14 is in the lowered cooking position, thereby permitting relatively free pivot of the arm 14 when in the cooking position.

As shown, a handle arrangement 120 is located at the front of the arm 14 to enable an operator to unlock the plate 104 and brackets 80 to permit the arm 14 to pivot. Specifically, each rod 112 extends forward through the arm body toward the handle arrangement 120 and has its end connected to the handle arrangement 120 at a location internal of the arm (per FIG. 8). The handle arrangement 120 includes two external handle members 122 and 124, with handle member 122 being fixed to the arm (e.g., via suitable fasteners or welding) and with handle member 124 being pivotally connected to the arm. As shown in FIG. 1, the attaching side arms of the handle member 124 extend along the front exterior of the arm body 16 and are connected to a pivot frame 126 internal of the arm body (see FIGS. 6 and 8) via a set of spacers 127 that are located internal of the arm body. The side arms of the handle member attach to the spacers 127 by a pair of screws and the pivot frame 126 is likewise connected to the spacers by screws. The spacers define the pivot axis for the handle member and pivot frame. In this regard, the spacers 127 have openings through which bolts (not shown) pass, with the internal ends of the bolts connecting to nuts internal of the arm body.

The pivot frame 126 includes spaced apart upright arms 128 with elongated slots 130 to which the ends of the rods 112 are pinned to provide both a pivoting and sliding connection. A yoke 132 is located within the arm body 16 to help guide and maintain a linear movement of the rods 112. In this regard, when the handle member 124 is pivoted downward in the direction of arrow 134 shown in FIG. 6, the frame arms 128 are likewise pivoted in the direction of arrow 136 which causes a linear movement of the rods 112 in the direction of arrow 138. As the rods are pulled in direction 112, the locking plate 104 is likewise pulled away from the brackets 80, retracting the plate from the bracket slots 102 and enabling pivot of the arm 14. When the handle member 124 is released, the biasing action of the springs 110 urges movement of the components in reverse directions. The lever action provided by the handle member 124 provides a mechanical advantage to the operator for disengaging the locking plate. By way of example, the mechanical advantage may be around 30%, but variations are possible.

Referring again to FIGS. 2 and 3, a lower edge of the handle member 124 interacts with an upper edge of the upper leg of the stabilizer 40 so that when the handle member 124 is moved downward toward the handle member 122, the interaction between the two edges causes the stabilizer to rotate out of contact with the griddle plate assembly.

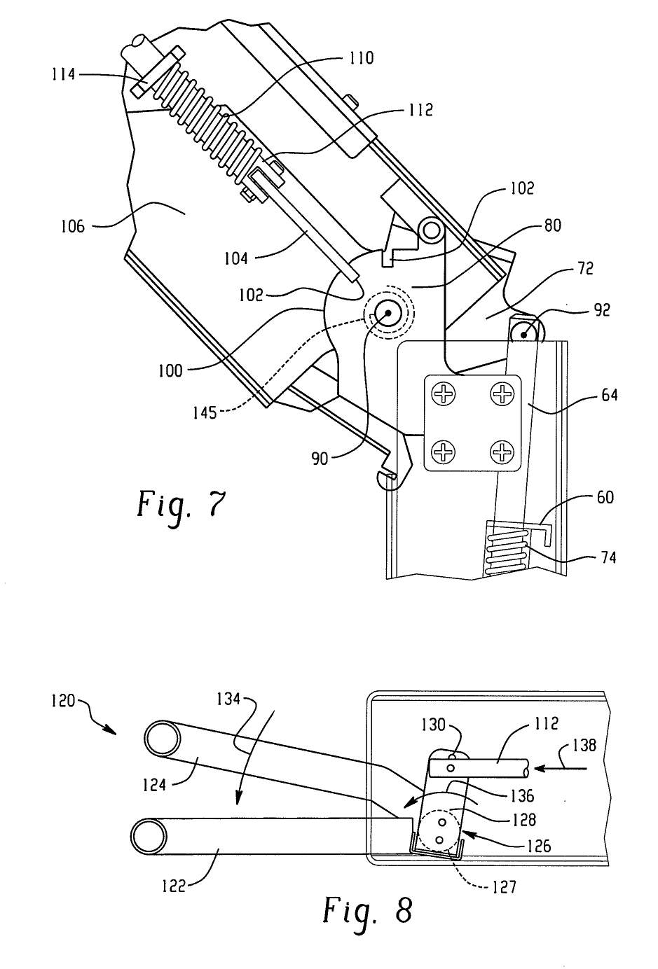

It is to be clearly understood that the above description is intended by way of illustration and example only, is not intended to be taken by way of limitation, and that other changes and modifications are possible. For example, as an alternative to the illustrated spring biasing system, a torsion spring type biasing mechanism could be provided with a torsion spring located on the primary pivot axis. By way of example, such a torsion spring 145 is shown in dashed line form in FIG. 7, where one side of the torsion spring could be fixed relative to the plate 80 of the mount column and the other side could be arranged to move with and urge the bracket 72, and thus the arm 14, upwards. In the case of use of such a torsion spring 145 arrangement the rods 64 and springs 74 could be eliminated. Other biasing arrangements could also be provided between the mount column and the arm.

What is claimed is:

1. An upper griddle mechanism for use with a cooking apparatus having a griddle plate with an upwardly facing cooking surface, the upper griddle mechanism comprising:
an upright mount column portion;
an arm portion pivotally connected to the mount column portion, the arm portion including an upper griddle plate, the arm portion pivotally movable relative to the mount column portion between a lowered cooking position and a raised non-cooking position,
a biasing mechanism mounted between the mount column portion and the arm portion to bias the arm portion.

2. The upper griddle mechanism of claim 1 wherein the biasing mechanism includes a spring and rod assembly extending upward along the mount column portion, an upper end of the rod pivotally connected to the arm portion, a height of the rod along the mount column portion varying as between the cooking position and the non-coking position of the arm portion.

3. The upper griddle mechanism of claim 2 wherein the rod moves upward as the arm portion is moved from the non-cooking position to the cooking position.

4. The upper griddle mechanism of claim 3 wherein a lower end of the spring moves upward as the rod moves upward and movement of the upper end of the spring is restrained, compressing the spring.

5. The upper griddle mechanism of claim 4 wherein the spring, when compressed, urges the rod to move back downward and thus the arm portion toward the non-cooking position, thereby counteracting downward weight of the arm portion when the arm portion is in the cooking position.

6. The upper griddle mechanism of claim 1 wherein the biasing mechanism acts to urge the arm portion toward the non-cooking position, thereby counteracting downward weight of the arm portion when the arm portion is in the cooking position.

7. The upper griddle mechanism of claim 6 wherein the arm portion has an actual weight W_{A} and the bias provided by biasing mechanism when the arm portion is in the cooking position urges the arm portion upward such that the arm portion has an effective weight W_{E}, the effective weight W_{E} is less than thirty percent 30% of the actual weight W_{A}.

8. The upper griddle mechanism of claim 1 wherein,
the biasing mechanism includes:
a bracket located on a body of the mount column portion, the bracket including a spring retainer with an opening therethrough, the bracket pivotally connected to the body at a location spaced below the spring retainer;
a rod passing through the opening of the spring retainer and having a lower end positioned below the spring retainer and an upper end positioned above the spring retainer, the rod movable through the opening relative to the spring retainer, the upper end of the rod pivotally connected to the arm portion;
a spring disposed about the rod below the spring retainer and having an upper end seated against the spring retainer and a lower end movable relative to the spring retainer and connected for upward movement with the lower end of the rod when the arm portion is moved from the non-cooking position to the cooking position, thereby compressing the spring when the arm portion is in the cooking position.

9. The upper griddle mechanism of claim 2 wherein,
the mount column portion includes a stationary upper locking bracket, the arm portion pivotally connected to the locking bracket to define a primary pivot axis of the arm portion for movement between the non-cooking position and the cooking position, the upper end of the rod is pivotally connected to the arm portion at a location spaced from the primary pivot axis to define a secondary pivot axis that runs parallel to the primary pivot axis.

10. The upper griddle mechanism of claim 9 wherein the arm portion includes a movable locking plate biased toward the locking bracket, the locking bracket includes at least one slot for receiving the locking plate when the arm portion is in the non-cooking position so as to releasably hold the position of the arm portion relative to the column portion.

11. The upper griddle mechanism of claim 10 wherein,
the arm portion includes a handle assembly at its distal end, the handle assembly operatively connected for movement of the locking plate away from the locking bracket, the handle assembly including a fixed handle portion and a pivoting handle portion, the pivoting handle portion biased away from the fixed handle portion and operatively connected with the locking plate such that movement of the pivoting handle portion toward the fixed handle portion moves the locking plate away from the locking bracket to enable the locking plate and arm portion to pivot relative to the locking bracket without interference from the locking bracket slot.

12. A cooking apparatus incorporating the upper griddle mechanism of claim 1, wherein the cooking apparatus includes an upwardly facing griddle surface, the mount column portion is mounted to the cooking apparatus and extends above the upwardly facing griddle surface, when the arm portion is in the cooking position a lower surface of the upper griddle plate opposes the upwardly facing griddle surface.

13. The cooking apparatus of claim 12 wherein the mount column portion includes a pair of vertically spaced apart and laterally extending slots, the cooking apparatus includes a pair of vertically spaced apart laterally extending mount brackets secured thereto, the mount brackets are positioned within the slots.

14. The cooking apparatus of claim 1 wherein the biasing mechanism comprises at least one of a torsion spring or a compression spring.

15. An upper griddle mechanism for use with a cooking apparatus having a griddle plate with an upwardly facing cooking surface, the upper griddle mechanism comprising:
an upright mount column portion;
an arm portion connected to the mount column portion, the arm portion including an upper griddle plate, the arm portion pivotally movable relative to the mount column portion between a lowered cooking position and a raised non-cooking position;
a locking mechanism for releasably holding the arm portion in the raised non-cooking position, the locking mechanism including a handle assembly located at an end of the arm portion that is spaced from the mount column portion, the handle assembly including a fixed handle portion and a pivoting handle portion, movement of the pivoting handle portion toward the fixed handle portion releases the locking mechanism to enable the arm portion to pivot from the raised non-cooking position to the lowered cooking position.

16. The cooking apparatus of claim 15 wherein the locking mechanism includes a locking bracket fixed to the mount column portion and a movable locking plate associated with the arm portion, a linking member connects the locking plate to the pivoting handle portion, pivoting movement of the pivoting handle portion relative to the fixed handle portion is translated into linear movement of the rod and locking plate.

17. The cooking apparatus of claim 16 wherein the linking member comprises a rod that extends through a rod support bracket, a spring is disposed about the rod between the rod support bracket and the locking plate to bias the locking plate and rod toward the locking bracket.

18. The cooking apparatus of claim 17 wherein the locking plate includes an arcuate slide surface facing the locking plate, the arcuate slide surface including at least one slot formed therein for receiving the locking plate when the arm portion is in the raised non-cooking position so as to releasably retain the arm portion in the raised non-cooking position.

19. The cooking apparatus of claim 18 wherein the arcuate slide surface lacks any slots positioned to interact with the locking plate when the arm portion is in the lowered cooking position, thereby permitting free pivot of the arm portion when in the cooking position.

20. A cooking apparatus incorporating the upper griddle mechanism of claim 15, wherein the cooking apparatus includes an upwardly facing griddle surface, the mount column portion is mounted to the cooking apparatus and extends above the upwardly facing griddle surface, when the arm portion is in the lowered cooking position a lower surface of the upper griddle plate opposes the upwardly facing griddle surface.

21. An upper griddle mechanism for use with a cooking apparatus having a griddle plate with an upwardly facing cooking surface, the upper griddle mechanism comprising:
an upright mount column portion;
an arm portion connected to the mount column portion, the arm portion including an upper griddle plate assembly, the arm portion pivotally movable relative to the mount column portion between a lowered cooking position and a raised non-cooking position, the upper griddle plate assembly floatingly connected to an arm body of the arm portion;
at least one stabilizer member that interacts with the griddle plate assembly when the arm portion is in the raised non-cooking position to restrict relative movement between the griddle plate assembly and the arm body.

22. The upper griddle mechanism of claim 21 wherein the stabilizer member is mounted for pivotal movement relative to the arm portion, the arm portion includes at least one movable handle, when the handle is moved a portion of the handle interacts with the stabilizer member to cause the stabilizer member to rotate out of contact with the griddle plate assembly.
